(19) United States
(12) Patent Application Publication
(10) Pub. No.: US 2022/0199270 A1
(43) Pub. Date: Jun. 23, 2022

(54) COOLANT CLEANUP SYSTEMS WITH DIRECT MIXING AND METHODS OF USING THE SAME

(71) Applicant: GE-Hitachi Nuclear Energy Americas LLC, Wilmington, NC (US)

(72) Inventors: John W. Holbrook, Wilmington, NC (US); Gary M. Anthony, Wilmington, NC (US)

(21) Appl. No.: 17/131,496

(22) Filed: Dec. 22, 2020

(51) Int. Cl. G21C 5/02; G21C 3/32; G21D 1/02

(52) U.S. Cl. CPC G21C 5/02; G21D 1/02; G21C 3/3206

(57) ABSTRACT

Cleanup systems include plural coolant inputs that are physically combined to create a single flow at a desired filtering temperature. Filter(s) are used to clean the coolant, and coolant flowing therethrough will damage the filter or not be adequately filtered if having temperature in excess of an operating temperature of the filter. The inputs have different temperatures, and mixing them creates a combined flow at a desired temperature. The amount of each flow is selected based on its individual temperature to achieve this desired temperature. The combined flow is then conditioned with the filter at an operable temperature and returned to the coolant origin for the inputs. No heat exchangers or heat loss to outside heat sinks are required. Cleanup systems may be used with any coolant loop, including Rankine-cycle electricity generation systems like nuclear power plants, combustion boilers, and steam generators, and heat transfer systems.

### BACKGROUND

FIG. 1 is a schematic of a related-art coolant cleanup system 60 in use with a boiling water reactor 10. As shown in FIG. 1, reactor 10 includes core 11 through which a fluid coolant, in this case light water, flows to absorb heat from fuel assemblies therein. Condensed liquid water is provided from main feedwater line 20 and may flow down through an annulus in reactor 10 and then back up through core 11. While flowing upward through core 11 in reactor 10, the coolant boils, and the resulting steam and heated water mixture passes through steam separator and drying structures 12. Supersaturated or dry steam then flows into a main steam leg 30 where its energy is extracted by turbines and a generator for electrical energy generation. The extracted steam is then typically recondensed by a condenser and secondary coolant loop and flows back into feedwater line 20, forming a loop. Containment 50 surrounds and impermeably contains reactor 10 and several incidental reactor systems to limit or prevent the passage of personnel and non-coolant material to and from reactor 10 and the surrounding environment.

Related art coolant cleanup system 60 is a smaller sub-loop of coolant to main feedwater 20 from reactor 10 and/or recirculation loop 25. Recirculation loop 25 may be a smaller loop of reactor water including jet pumps and diffusers to drive flow through the annulus. The coolant loop in cleanup system 60 includes cleanup feed line 61 taking liquid coolant from the annulus or lower portion of reactor 10 or recirculation loop 25 and cleanup injection line 67 connecting to feedwater line 20. In this way, all liquid coolant flowing through cleanup system 60 may be liquid feedwater from and to a single source of water for reactor 10. System 60 includes pump 62 to drive the coolant through the loop, and filter 65 to remove impurities from the reactor water. Filter 65 may include various mechanical and chemical filters and cleaners, including porous filters, trap-type filters, osmosis filters, resin bed filters, chemical dispersants, demineralizers, etc. to remove contaminants and otherwise control coolant makeup and chemistry that may become damaging if left to concentrate and/or deposit in reactor 10.

Because most chemical and fine material filters and cleaners function at temperatures at or below 128° F., well below reactor temperatures, the coolant must first be cooled through heat exchangers 63 and 64 before reaching filter 65 to avoid damaging the same. External heat exchanger 64 may be a nonregenerative filter passing coolant from external loop 66 through a tube-in-tube, cross-channel, or other type of strict separation heat exchanger medium to substantially cool the water in system 60 below a limit temperature of filter 65. Similarly, internal regenerative heat exchanger 63 may pass filtered and unfiltered water in system 60 in a strict separation configuration to initially cool water for cleanup from cleanup feed line 61 and heat up cleaned water for cleanup injection line 67. Because water flowing throughout cleanup system 60 is primary coolant passing through reactor 10, all heat exchangers 63 and 64 and all other flow paths must completely keep separate this water from external loop 66, from other flow points of the same water, and from other external systems to maintain containment and maintain control over coolant chemistry and other makeup at all coolant flow points. In the US and many other countries operating commercial nuclear electricity plants, laws and regulations require strict separation and monitoring of such cleanup lines to prevent intermixing and maintain such control. US Patent Publication 2005/0117690 published Jun. 2, 2005 to Hemmi et al. and U.S. Pat. No. 5,375,151 issued Dec. 20, 1994 to Gluntz et al. describe similar related art reactor cleanup systems with filters fed from regenerative and nonregenerative heat exchangers and are incorporated by reference herein in their entireties.

### SUMMARY

Example embodiments include coolant conditioning systems and heat transfer systems with coolant loops having the same. In heat transfer systems, coolant flows through piping and other flow-carrying structures to transfer energy from a heat source to an energy extractor, such as from a combustion-, fission-, solar-, and/or geothermal-based heat source pumped to a turbine, condenser, radiator, etc. The overall system may be largely closed, such that impurities can build up in the coolant over time, especially in the heat source, and example embodiment coolant subsystems remove these impurities by sampling and cleaning the coolant from the coolant loops and even directly from the heat source. Cleanup systems may include filter(s) of varying type and effect used for this cleaning, and they have maximum operating temperatures of coolant, beyond which filtering is less effective and/or materials in the filter(s) are damaged. The mixing system has relatively cold and hot intakes, such as piping feeds flowing from the coolant loop at cold and hot positions of the coolant. For example, these intakes may be where the coolant is cold after being introduced or after being cooled by a heat sink, and where the coolant is hot from the heat source. These two flows are intermixed to create a combined flow at a temperature between the two without flow interruption. The amount of each flow is selected based on its temperature to achieve a temperature that, when mixed back into the coolant loop, is below the maximum temperature of the filter. The combined flow then transits back into the coolant loop and passes through the filter, including all cleanup apparatuses, to remove unwanted aspects of the coolant at an operable temperature, prior to entering the heat source.

Although they may be used, no segregating systems, such as a heat exchanger, are required between the hot and cold intakes, and no other or outside cooling or heat sink needs to be used to cool the hot intake, due to the direct mixing of the intakes. The relative flows through the intakes may be controlled with valves, thermal regulators, choke plates, temperature sensors and other flow controls to achieve the mixing closer to or below the filter's maximum temperature. Example embodiment coolant cleanup systems may be used to condition any coolant loop where impurities may build up, including Rankine-cycle electricity generation systems, heat transfer systems, and any other system using a coolant at varying temperatures. This may include liquid and vapor water used in a boiling water nuclear reactor with primary coolant being pumped from turbines and condensers after being boiled in the reactor.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is a schematic of a related art coolant cleanup system.

FIG. 2 is a schematic of an example embodiment energy extraction system with example embodiment direct mixing coolant subsystem.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Modifiers “first,” “second,” “another,” etc. may be used herein to describe various items, but they do not confine modified items to any order or relationship. These terms are used only to distinguish one element from another; where there are “second” or higher ordinals, there merely must be that many number of elements, without necessarily any difference or other relationship between elements. For example, a first element could be termed a second element, and, similarly, a second element could be termed a first element, unless an order or difference is separately stated. In listing items, the conjunction “and/or” includes all combinations of one or more of the associated listed items. The use of “etc.” is defined as “et cetera” and indicates the inclusion of all other elements belonging to the same group of the preceding items, in any “and/or” combination(s).

When an element is related, such as by being “connected,” “coupled,” “mated,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two devices, including intermediary devices, networks, etc., connected wirelessly or not.

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Possessive terms like “comprises,” “includes,” “has,” or “with” when used herein, specify the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude the presence or addition of multiple or other subject matter in modified terms.

The structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, so as to provide looping or other series of operations aside from single operations described below. It should be presumed that any embodiment or method having features and functionality described below, in any workable combination, falls within the scope of example embodiments.

The inventors have recognized that heat exchangers require complex piping and increase safety and monitoring burdens in nuclear power plants and, especially external heat exchangers, lose a significant amount of energy to an outside coolant or heat sink that cannot be used for electrical generation or other work in the overall system. The inventors have further recognized that strict separation between coolant sources and accounting for coolant chemistry may be of less concern in a system with larger filtering capacity, potentially filtering capacity for all coolant flow. The inventors have developed example embodiments and methods described below to address these and other problems recognized by the Inventors with unique solutions enabled by example embodiments.

The present invention is coolant mixing systems with combined coolant flows from different-temperature origins, energy transfer systems using the same, and methods of operating the same. In contrast to the present invention, the few example embodiments and example methods discussed below illustrate just a subset of the variety of different configurations that can be used as and/or in connection with the present invention.

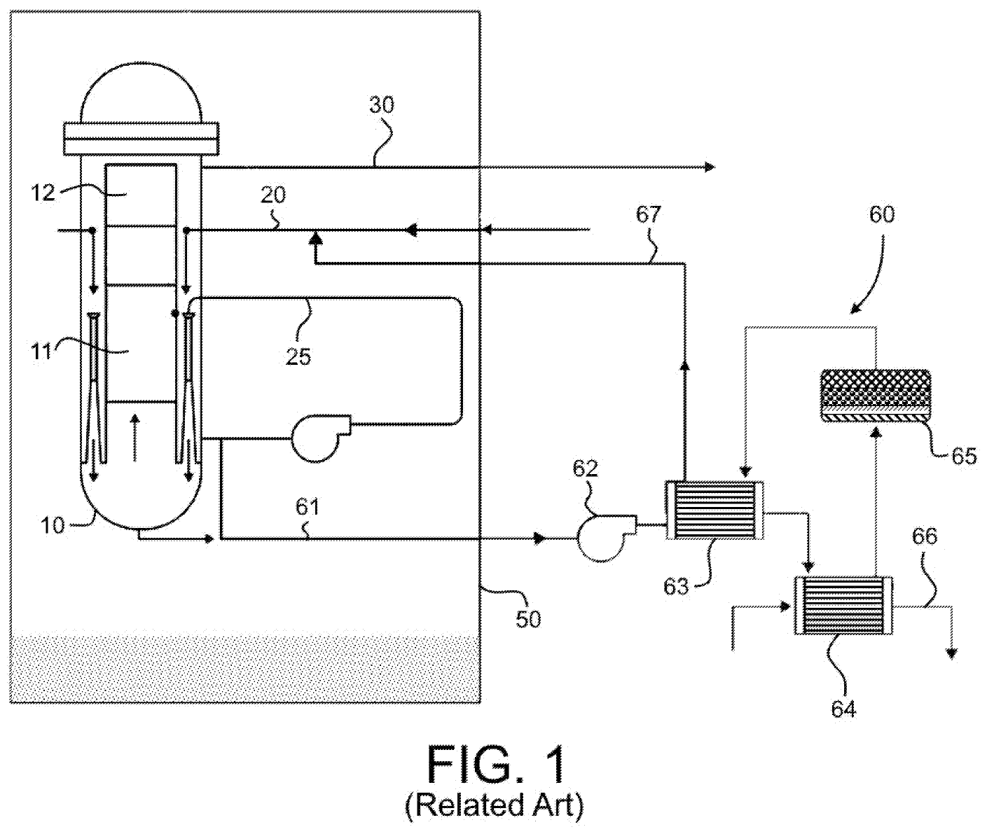

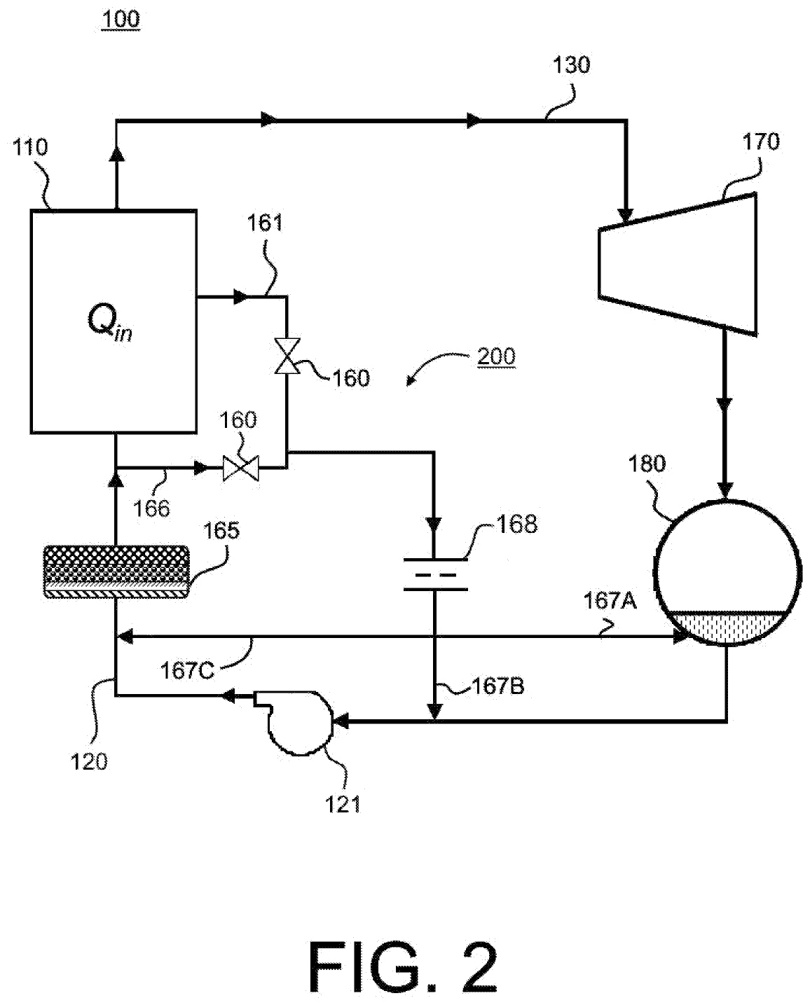

FIG. 2 is a schematic of an example embodiment energy extraction system 100 using an example embodiment direct mixing coolant subsystem 200. As shown in FIG. 2, example embodiment system 100 may use a loop of fluid heat transfer medium, or coolant, passing through energy generation and extraction apparatuses. Enthalpy source 110 heats and/or pressurizes the coolant, such as through boiling a liquid coolant into a vapor. Enthalpy source 110 may be, for example, a steam generator, a coal boiler, a furnace, a boiling water reactor such as reactor 10 (FIG. 1), a geothermal heat source such as an underground thermal seam, a solar collector, etc.

Hot leg 130, such as a main steam leg in a boiler or boiling water reactor for example, carries the energized coolant for energy extraction. For example, turbine 170 may be connected to hot leg 130 and extract energy from the coolant to drive an electrical generator or other work output. Turbine 170 may be a multi-stage turbine extracting energy from several different pressure levels of coolant. Coolant may pass through condenser 180 or other heat sink, potentially after being depressurized from turbine 170, to condense and/or cool the coolant or otherwise remove heat and/or pressure from the coolant for delivery back to enthalpy source 110. Return leg 120 feeds the lower-energy coolant back to enthalpy source 110, potentially with feed pump 121 aiding return and driving flow through the loop.

Example embodiment direct mixing coolant subsystem 200 takes and returns coolant from/to system 100 and adjusts the same to temperatures acceptable for cleanup. As shown in FIG. 2, example subsystem 200 includes cold feed line 166 taking coolant from a cold point of return leg 120 and hot feed line 161 taking coolant from a hot point of enthalpy source 110. For example, cold feed line 166 may be off feedwater line 20 (FIG. 1) or return leg 120 just after pump 121 and/or feed filter 165, providing primary, environmental, or reserve coolant where coolant is at a lower temperature. Similarly for example, hot feed line 161 may take from just below a liquid level in enthalpy source 110, from a lower plenum or core of reactor 10 (FIG. 1), from a steam separator, etc., wherever coolant is at a hot point with high amounts of impurities, debris, and/or other residue that may accumulate in the heated coolant and/or enthalpy source 110.

Hot feed line 161 and cold feed line 166 directly mix the coolant in subsystem 200 from their respective points, bringing the coolant closer to or below a filter limit temperature, such as nearer 128° F. for liquid water, that will not damage a filter while allowing desired coolant conditioning. Flow valves 160 may balance coolant flow from hot feed line 161 and cold feed line 166 to achieve the desired temperature while avoiding flashing, or vaporization, of hot coolant from line 161. Cold feed line 166 connecting after pump 121, may be of sufficiently high pressure coming through flow valve 160 to directly mix with and cool coolant in hot feed line 161 without flashing due to the resulting mixed pressure remaining higher than the coolant's boiling point.

For example, coolant from hot feed line 161 may be extremely hot, far above a filter limit temperature, while coolant from cold feed line 166 may be nearer the filter limit temperature. In this example, valves 160 may be adjusted to allow larger amounts of flow from cold feed line 166 and smaller amounts of flow from hot feed line 161. When flows from lines 161 and 166 mix well, the temperature of a combined flow is closer to or below filter limit temperature, and the pressure throughout system 200 and after valves 160 is sufficiently high to prevent vapor formation or vapor blocking. Valves 160 may be manually or automatically adjusted based on temperature and/or pressure sensors on lines 161 and 166. Similarly, valves 160 may be a single mixer or flow combiner taking flows in proportion to achieve the temperature closer to the filter limit temperature. Alternatively or additionally, any other flow balance or mixing apparatus, including flow orifices, temperature control valves, thermal regulators, mixing tanks, etc. may be used to achieve the desired mixed, single-phase flow at a desired temperature. Similarly, one or more pumps may drive coolant flow and ensure pressures remain high enough to prevent vaporization through example embodiment subsystem 200.

Mixed, equilibrium coolant then flows out of example embodiment subsystem 200 into return leg 120. The equilibrium coolant is cooler and nearer the limit temperature for a filter than coolant from hot feed line 161, and when the coolant mixes in return leg 120, the coolant further cools to or below the limit temperature, such as below 128° F. for liquid water running through a resin bed filter, including 125° F., 120° F., 100° F., and the like. The filtered coolant may be provided back via several points to the main coolant loop. As shown in FIG. 2, this may include return lines 167A, 167B, and 167C returning to several different points, including to a liquid level in condenser 180, before pump 121 on return leg 120, and/or after pump 121 on return leg 120, respectively. Lines 167A, 167B, and 167C may be used singly or in any combination, potentially with flow mixers, diverters, and valves to control desired coolant return points and rates to ensure the further mixed coolant is below the limit temperature.

Because flashing to vapor is less of a concern in return lines 167 carrying cooler equilibrium flow, pressure may be reduced in the mixed equilibrium flow before being returned to a main coolant loop. Several different apparatuses may be intervening to reduce pressure for injection back into return leg 120, including orifice plate 168, flow trippers, diffusers, etc. The volume of coolant driven through subsystem 200 may be a small fraction from the flow through the larger coolant loop of system 100, sufficient only to remove contaminant buildup from enthalpy source 110.

Because example embodiment subsystem 200 directly mixes coolant from a same loop and uses no heat exchangers, no energy is lost to the environment through cooling down to closer to a filter temperature. In this way, “self”-cooled coolant directly from a large impurity source like enthalpy source 110 may be provided directly back into the coolant loop in example embodiment systems. The direct mixing also significantly simplifies subsystem 200 and system 100, eliminating the need for heat exchangers and external coolant and all associated piping. While this directly mixes coolant from two different locations in a loop that might otherwise be proscribed by coolant chemistry regulations, the single-phase flow and use of a coolant conditioner described below or other filter allows control of resulting coolant chemistry.

Example embodiment subsystem 200 may be used in a Rankine power cycle, like that shown in FIGS. 1 and 2, with any number of different hot and cold feed sources. Similarly, subsystem 200 may be used with feedwater or emergency coolant systems, where the hot feed source may be a shutdown reactor or boiler or heat exchanger. Cold feed lines may take from any source of coolant that is closer to or below the filter limit temperature, including storage pools, emergency tanks, driven feedwater, environmental sources, etc. For example, subsystem 200 may operate inside of or across a nuclear reactor containment as shown in FIG. 1, where components may be insulated and hardened against radiation and operating temperatures, and, with simplified designs lacking heat exchangers, sized to fit within a nuclear power plant.

Example embodiment energy extraction system 100 includes feed filter 165, which may include various mechanical and chemical filters and cleaners, including porous filters, trap-type filters, osmosis filters, resin bed filters with cross-linked polymers and/or anion/cation exchange materials, chemical dispersants, demineralizers, etc. Feed filter 165 operates efficiently and without damage at or below the filter limit temperature. Feed filter 165 may be sized to condition all of the incoming flow on return leg 120, which may include all coolant from condenser 180 and equilibrium coolant from mixing subsystem 200. In this way, feed filter 165 may clean up all coolant flowing into enthalpy source 110, including the coolant taken directly from hot points of enthalpy source 110 via hot feed line 161 and then cooled. With proper mixing of colder feeds from cold feed line 166 and return leg 120 via example embodiment mixing subsystem 200, flow into filter 165 is at or below the limit temperature for filter 165. This temperature-acceptable flow may nonetheless include flow from hot feed line 161 carrying larger amounts of impurities, debris, and other non-coolant material from enthalpy source 110, and filter 165 may be able to filter out these unwanted materials nearly directly.

Some example embodiments and methods thus being described, it will be appreciated by one skilled in the art that examples may be varied through routine experimentation and without further inventive activity. For example, although mixed media filters including a resin bed are used with liquid water in some example systems, it is understood that other coolant conditioning apparatuses and coolant media are useable with examples. Variations are not to be regarded as departure from the spirit and scope of the example embodiments, and all such modifications as would be obvious to one skilled in the art are intended to be included within the scope of the following claims.

What is claimed is:

1. A power generation system comprising:
a coolant loop carrying a fluid coolant;
a heat source on the coolant loop configured to add energy to the fluid coolant;
a filter having a limit temperature at which the filter is damaged by the fluid coolant and below which the filter is configured to remove impurities from the fluid coolant;
an energy extraction apparatus on the coolant loop configured to remove energy from the fluid coolant; and
a coolant mixing subsystem including,
a cold intake connected to the coolant loop at a position after the energy extraction apparatus and before the heat source in the direction of fluid coolant flow through the coolant loop,
a hot intake connected to the heat source, wherein the hot intake and the cold intake are in fluid connection so as to directly mix the fluid coolant from the hot intake and the cold intake together to form a combined flow of the fluid coolant, and
a return line connected to the hot intake, the cold intake, and the coolant loop so as to return the combined flow to the coolant loop before the filter in the direction of fluid coolant flow, wherein the coolant mixing subsystem mixes the combined flow into the coolant loop so the fluid coolant is below the limit temperature when entering the filter.

2. The system of claim 1, wherein the coolant mixing subsystem does not include a heat exchanger or an external coolant flow.

3. The system of claim 1, wherein the filter includes a resin bed filter configured to filter liquid water as the fluid coolant, wherein the limit temperature is 128° F., and wherein the resin bed is damaged by coolant at any temperature above the limit temperature.

4. The system of claim 1, wherein the cold intake and the hot intake include at least one valve configured to control a flow rate in the cold intake and the hot intake.

5. The system of claim 1, wherein the heat source is at least one of a steam generator, a boiling water reactor, a combustion burner, a solar collector, and a geothermal heat source.

6. The system of claim 1, wherein the energy extraction apparatus is at least one of a turbine and a condenser.

7. The system of claim 1, wherein the fluid coolant is water, and wherein the heat source is configured to boil the water so that only steam flows in the coolant loop from the heat source to the energy extraction apparatus.

8. The system of claim 1, further comprising:
a pump configured to drive the fluid coolant from the energy extraction apparatus to the heat source.

9. The system of claim 1, wherein the heat source is a boiling water reactor and the coolant is water, wherein the coolant loop includes a feedwater inlet for the reactor and a main steam leg from the reactor, and wherein the hot intake connects to the reactor and the cold leg connects to the feedwater inlet.

10. The system of claim 9, wherein the filter includes a resin bed filter configured to filter the water only below 128° F., and wherein the coolant mixing system does not include a heat exchanger or an external coolant flow.

11. A coolant mixing system for use with a power generation system, the coolant mixing system comprising:
a cold intake configured to connect to and receive fluid coolant from a coolant loop of the power generation system;
a hot intake configured to connect to and receive fluid coolant from a heat source in the power generation system, wherein the hot intake and the cold intake are in fluid connection so as to directly mix the fluid coolant from the hot intake and the cold intake together to form a combined flow of the fluid coolant, and
a return line connected to the hot intake and the cold intake, wherein the return line is configured to return the combined flow to the coolant loop, wherein the coolant mixing subsystem mixes the combined flow into the coolant loop so the fluid coolant is below a limit temperature of a filter on the coolant loop.

12. The system of claim 11, wherein the coolant mixing system does not include a heat exchanger or an external coolant flow.

13. The system of claim 11, further comprising:
the coolant loop; and
the filter, wherein the filter includes a resin bed filter configured to filter liquid water as the fluid coolant, wherein the limit temperature is 128° F., and wherein the resin bed is damaged by coolant at any temperature above the limit temperature.

14. The system of claim 13, wherein the filter is sized to filter all feedwater flowing from the coolant loop into the heat source, and wherein the entire system is configured to operate in an operating nuclear reactor environment.

15. The system of claim 11, wherein the cold intake and the hot intake include at least one valve configured to control a flow rate in the cold intake and the hot intake so the combined flow is below the limit temperature when mixed into the coolant loop.

16. A method of cleaning up fluid coolant in a power generation system, the method comprising:
flowing the fluid coolant through a coolant loop from a heat source adding energy to the fluid coolant to an energy extraction apparatus removing energy from the fluid coolant and back to the heat source;
flowing the fluid coolant into a coolant mixing subsystem through a hot intake from the heat source and a cold intake from a position on the coolant loop after the energy extraction apparatus and before the heat source in the direction of flowing;
directly mixing the fluid coolant from the hot intake and the cold intake together to form a combined flow of the fluid coolant; and
flowing the combined flow back into the coolant loop through a return line such that the fluid coolant is below a limit temperature of a filter on the coolant loop.

17. The method of claim 16, wherein the flowing the fluid coolant into the coolant mixing subsystem, the directly mixing, and the flowing the combined flow back into the coolant loop do not use a heat exchanger or an external coolant flow.

18. The method of claim 16, further comprising:
Flowing the fluid coolant from the coolant loop into the filter and then into the heat source, wherein the filter includes a resin bed filter configured to filter liquid water as the fluid coolant, wherein the limit temperature is 128° F., and wherein the resin bed is damaged by coolant at any temperature above the limit temperature.

19. The method of claim 16, further comprising:
adjusting valves on the cold intake and the hot intake to control a flow rate in the cold intake and the hot intake so the combined flow is below the limit temperature.

20. The method of claim 16, wherein the flowing the fluid coolant through the coolant loop includes pumping the fluid coolant through an operating nuclear reactor, turbine, and condenser.
